(19) United States
(12) Patent Application Publication
(10) Pub. No.: US 2015/0186922 A1
(43) Pub. Date: Jul. 2, 2015

(54) BIFURCATED ECOMMERCE BACKEND FOR INLINE VIDEO AD PLAYER

(71) Applicant: Go Daddy Operating Company, LLC, Scottsdale, AZ (US)

(72) Inventor: Arnold Blinn, Hunts Point, WA (US)

(21) Appl. No.: 14/146,395

(22) Filed: Jan. 2, 2014

(51) Int. Cl. G06Q 30/02

(52) U.S. Cl. CPC G06Q 30/0241

(57) ABSTRACT

The invention includes a video player, running on a customer client, that displays a video to a customer. A video server may stream the video and advertisement information to the video player. An interactive advertisement may be overlaid over the video, preferably at, or between, particular cue points in the video. The customer may interact with the advertisement, possibly by clicking on the advertisement, to initiate a commercial transaction. The video player may be integrated (communicates) with the third party ecommerce functionality run on an ecommerce server. The integration allows the customer to complete the commercial transaction from the video player, i.e., without being redirected to the ecommerce server. This allows the video server to be owned and operated by a different entity than the entity that owns or operates the ecommerce functionality run on the ecommerce server.

### FIELD OF THE INVENTION

The present invention generally relates to the field of ecommerce and specifically to the field of overlaying videos with interactive advertisements.

### SUMMARY OF THE INVENTION

The present invention provides systems and methods for a video player, running on a customer client, to display a video to a customer wherein the video is streamed from a video server. One or more interactive advertisements may be overlaid over the video. The advertisements may be continuously overlaid, but are preferably overlaid between cue points in the video. The customer may interact with one or more advertisements, possibly by clicking on an advertisement, to initiate a commercial transaction.

In one possible embodiment, the customer is redirected to a third party ecommerce functionality, which could include, as a non-limiting example, an electronic shopping cart, to complete the commercial transaction. The ecommerce functionality may be run on an ecommerce server. After the commercial transaction is completed, the customer may be redirected back to the video player.

In another possible embodiment, the video player is integrated with the third party ecommerce functionality. The integration allows the customer to complete the commercial transaction from the video player without being redirected, linked, and/or moved in any manner, to a different server (such as an ecommerce server). The video player may communicate and coordinate the commercial transaction with the ecommerce functionality on the other server in a manner transparent to the customer. As an example, the customer client may perform HTTP requests to the ecommerce server and receive response messages back to communicate and coordinate the commercial transaction with the ecommerce functionality on the ecommerce server. The coordination may require the video player to be integrated with the ecommerce functionality, whereby the video player is functionally compatible with the ecommerce functionality running on the ecommerce server. In other embodiments, an API, remote calls, or any other method now known or later developed that would allow the video player to coordinate the commercial transaction with the ecommerce functionality may be used.

Both embodiments allow the video server to be owned and/or operated by a different entity than the entity that owns and/or operates the ecommerce server and ecommerce functionality. This also allows the video server and the ecommerce server to reside at different geographical locations and be different servers. Both embodiments also allow the ecommerce functionality to be controlled by a third party, i.e. not the owner or operator of the video server.

The above features and advantages of the present invention will be better understood from the following detailed description taken in conjunction with the accompanying drawings.

### BRIEF DESCRIPTION OF THE DRAWINGS

FIG. 1 is a block diagram of one possible system for practicing the invention.

FIG. 2 is a flow diagram illustrating a possible embodiment of a method for redirecting a customer from a video player to an ecommerce server.

FIG. 3 is a flow diagram illustrating another possible embodiment of a method for completing a commercial transaction using a video player integrated with an ecommerce functionality running on a different server.

FIG. 4 is a flow diagram illustrating another possible embodiment of a method for completing a commercial transaction using an interactive advertisement, running on a customer client, integrated with an ecommerce functionality, running on an ecommerce server.

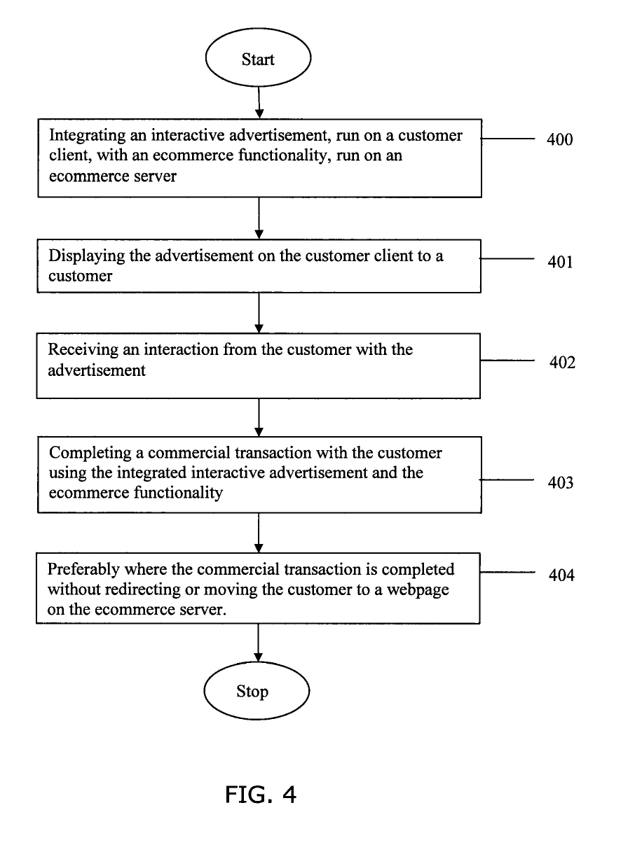

### DETAILED DESCRIPTION

The present inventions will now be discussed in detail with regard to the attached drawing figures that were briefly described above. In the following description, numerous specific details are set forth illustrating the Applicant's best mode for practicing the invention and enabling one of ordinary skill in the art to make and use the invention. It will be obvious, however, to one skilled in the art that the present invention may be practiced without many of these specific details. In other instances, well-known machines, structures, and method steps have not been described in particular detail in order to avoid unnecessarily obscuring the present invention. Unless otherwise indicated, like parts and method steps are referred to with like reference numerals.

A network is a collection of links and nodes (e.g., multiple computers and/or other devices connected together) arranged so that information may be passed from one part of the network to another over multiple links and through various nodes. Examples of networks include the Internet, the public switched telephone network, the global Telex network, computer networks (e.g., an intranet, an extranet, a local-area network, or a wide-area network), wired networks, and wireless networks.

The Internet is a worldwide network of computers and computer networks arranged to allow the easy and robust exchange of information between computer users. The amount of infrastructure (hardware and software) required to keep the Internet operating is massive and continues to rapidly grow. The Internet may comprise, as a very, very, small selection of hardware examples, rack servers, routers, and/or any other hardware or software currently known or developed in the future.

Hundreds of millions of people around the world have access to computers connected to the Internet via Internet Service Providers (ISPs). Content providers place multimedia information (e.g., text, graphics, audio, video, animation, and other forms of data) at specific locations on the Internet referred to as websites. The combination of all the websites and their corresponding webpages on the Internet is generally known as the World Wide Web (WWW) or simply the Web.

For Internet users and businesses alike, the Internet continues to be increasingly valuable. More people use the Web for everyday tasks, from social networking, shopping, banking, and paying bills to consuming videos, media and entertainment. E-commerce is growing, with businesses delivering more services and content across the Internet, communicating and collaborating online, and inventing new ways to connect with each other.

Prevalent on the Web are multimedia websites, some of which may offer and sell goods and services to individuals and organizations. The websites may display advertisements on the webpages. The advertisements may be for goods and services offered by the owner/operator of the website and/or the advertisements may be for goods and services offered by third parties.

Websites may consist of a single webpage, but typically consist of multiple interconnected and related webpages. Websites, unless extremely large and complex or have unusual traffic demands, often reside on a single server and are prepared, maintained, owned, and operated by a single individual or entity. Menus and links may be used to move between different webpages within the website or to move to a different website as is known in the art. The interconnectivity of webpages enabled by the Internet can make it transparent to the Internet users where one website ends and another begins. Internet users (or customers) may be redirected by a first webpage to a second webpage, with the second webpage possibly in a different website and operated on a different server than the first webpage. It might even have the same look and feel.

Websites may be created using HyperText Markup Language (HTML) to generate a standard set of tags that define how the webpages for the website are to be displayed. Users of the Internet may access content providers' websites using software known as an Internet browser, such as MICROSOFT INTERNET EXPLORER or MOZILLA FIREFOX. After the browser has located the desired webpage, it requests and receives information from the webpage, typically in the form of an HTML document, and then displays the webpage content for the user. The user may then view other webpages at the same website or move to an entirely different website using the browser.

Some website owners, typically those that are larger and more sophisticated, may provide their own hardware, software, and connections to the Internet. But many website owners either do not have the resources available or do not want to create and maintain the infrastructure necessary to host their own websites. To assist such individuals (or entities), hosting companies exist that offer website hosting services. These hosting providers typically provide the hardware, software, and electronic communication means necessary to connect multiple websites to the Internet. A single hosting provider may literally host thousands of websites on one or more hosting servers.

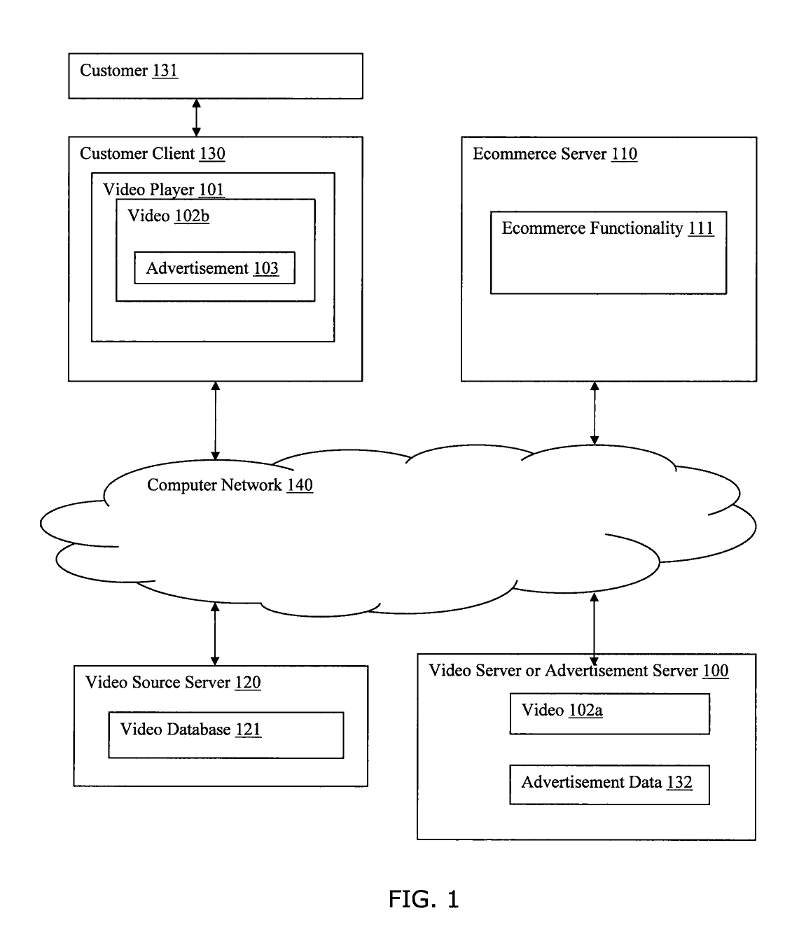

The invention will now be described with reference to FIG. 1. The invention may include a video server or an advertisement server 100, an ecommerce server 110, and a video source server 120 that may communicate over a computer network 140, such as the Internet. Each of these servers 100, 110, 120 may represent a distinct server or be a group of servers (or pod(s)), owned and operated by different entities, and/or operated from different geographical locations, i.e., not in the same building or facility. Increased Internet traffic may require additional servers 100, 110, 120 to be used to perform each function. This configuration allows a third party entity (different from the entity operating the video server 100) to control the ecommerce functionality 111 (which may include some or all of the features of an electronic shopping cart) operated on the ecommerce server 110.

In other embodiments, one or more of the servers 100, 110, 120 may share functions. As an example, the video server 100 may perform the function(s) of the video source server 120 with the video server 100 storing the video database 121. Thus, in some embodiments, the functions of the servers 100, 110, 120 may overlap and be performed on the same servers. As a non-limiting example, one or more of the servers (video server 100, ecommerce server 110, and video source server 120) may be a Dell PowerEdge Server or any other known or later developed server(s).

In a preferred embodiment, the video source server 120 comprises the hardware and software necessary, among other functions, to store data for one or more videos 102 in a video database 121. The video database 121 may be accessed by other servers over the computer network 140. The video server 100 comprises the hardware and software required to stream video 102a and advertisement data 132 to a video player 101 operated on a customer client 130. The ecommerce server 110 comprises the hardware and software necessary to support ecommerce functionality 111.

Internet users may be customers 131, i.e., people that purchase, use, and/or consume the services and products offered by websites. Customers 131 may use browsers, installed on their customer clients 130, to access information on the web and purchase services and goods. Customers 131 may also install a video player 101 on the customer client 130 for displaying videos 102b or the video player 101 may be created by the browser using HTML and/or scripts received from a website. Customers' clients 130 may be, as non-limiting examples, PDAs, cell phones, tablets, laptops, and/or stationary computers.

The video player 101 may be any type of video player currently known or developed in the future. As a non-limiting example, the customer client 130 running a browser may create a video player 101 from the HTML code and scripts (such as Java scripts) received from the video server 100. The video server 100 may then stream a video 102a to the video player 101 to permit the video player 101 to display the video 102b to the customer 131. The video player 101 may use the customer client's 130 hardware and software to operate.

Displaying one or more advertisements 103 on a website is a common method for generating revenue. The advertisements 103 may be offers to sale products and services offered by the operator/owner of the website, but may also be offers to sale products and services offered by a third party. While advertisements 103 may simply be information regarding a product or service, Internet technology allows the advertisements 103 to be interactive. An interactive advertisement 103 allows a customer 131 to interact with the advertisement, such as, as a non-limiting example, by clicking directly on the advertisement 103 or a particular area within the advertisement 103. Interacting with an advertisement 103 indicates to the website that the customer 131 desires more information and/or to purchase the advertised product or service.

An advertisement 103 may be overlaid on a video 102 being played on a video player 101. This approach has the advantage of displaying the advertisement 103 where the customer 131 is most likely to be looking at. The advertisements 103 may be sized and located in the display area of the video player 101 so as to not completely obscure the video 102, but yet effectively present the advertisement 103 to the customer 131.

Ecommerce functionality 111 allows a piece of ecommerce software operated on the ecommerce server 110 to permit customers 131 to perform one or more ecommerce functions and possibly complete a commercial transaction. The ecommerce functionality 111 may include, as non-limiting examples, selecting items for eventual purchase, collecting discount coupons or promotional codes, totaling the costs of the selected items (often including shipping costs and taxes), collecting payment and shipping information, storing purchase information, confirming and/or finalizing the purchase, receiving payment, and/or initiating procedures to perform the purchased services or delivering the purchased items.

In one possible embodiment of the invention, the video player 101, operated on the customer client 130, may redirect the customer 131 to a webpage on an ecommerce server 110 (such as by using HTML redirect code) running ecommerce functionality 111. The ecommerce functionality 111 may perform the various functions needed to complete a commercial transaction with the customer 131. After completing the transaction, the customer 131 may be redirected back to the webpage the customer 131 was browsing prior to interacting with the advertisement (again, possibly using an HTML redirect code). In another embodiment, a link may be used to redirect the customer 131 back to the webpage the customer 131 was browsing prior to interacting with the advertisement. In yet another embodiment, the ecommerce functionality 111 may have been opened in a new browser window, without closing the webpage with the video player.

In another embodiment of the invention, the ecommerce functionality 111 is integrated with the video player 101. This embodiment does not require the customer's 131 browser to be redirected to a webpage on another server. During and/or after the commercial transaction, the video player 101 may communicate with the ecommerce functionality 111, performed on the ecommerce server 110, to coordinate the commercial transaction. The integration of the video player 101 and the ecommerce functionality 111 may be accomplished by overlaying additional HTML and/or scripts on top of the video player 101. The communication between the video player 101 and the ecommerce functionality 111 is preferably bidirectional and in real time with the commercial transaction. The communication may be by any known communication protocol or method now known or developed in the future. In other non-limiting embodiments, the video player 101 may communicate with the ecommerce functionality 111 using an API or a remote procedure call.

In a preferred embodiment, the video server 100 and ecommerce server 110 are different servers, owned and operated by different people/entities, and/or located in different geographical locations. These possible configurations allow the ecommerce functionality 111 to be controlled by a third party different from the owner/operator of the video player 101. This bifurcation allows one person/entity to own and operate the video server 100 and a different person/entity to own and operate the ecommerce functionality 111 running on the ecommerce server 110.

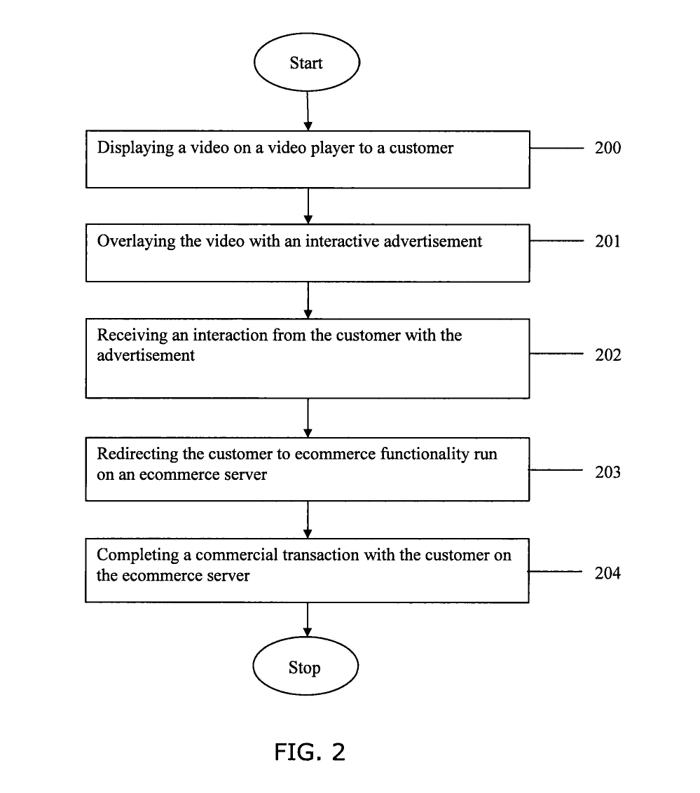

One method for practicing the invention will now be described with reference to FIG. 2. In this embodiment, a customer 131, using a browser installed on a customer client 130, may receive HTML and/or scripts from a video server 100. The browser, HTML, and/or scripts may be used to create a video player 101 on the customer client 130. The video server 100 may stream video 102a to the customer client 130 so that the customer 131 may see the video 102b on the video player 101. The customer 131 may select a video 102a to view. The video server 100 may have the data for the video 102a or the video server 100 may have to request the data from a video database 121 operated on a video source server 120. Once the video server 100 has access to the video 102a, the video server 100 may stream the video 102a to the video player 101 run on the customer client 130. (Step 200)

The video server 100 may also access advertisement data 132 for an interactive advertisement 103 and transmit this information to the customer client 130. The advertisement 103 may be displayed on the video player 101 at any time. (Step 201) In one embodiment, the advertisement 103 is always overlaid on the video 102 (i.e., the customer 131 can view parts of the video 102 and the advertisement 103 at the same time) and in another embodiment the advertisement 103 is overlaid on the video 102b at a particular cue point, or between particular cue points, in the video 102b to maximize the effect of the advertisement 103. In a preferred embodiment, the advertisements 103 are timed to be overlaid on the video 102b during a period of time in the video 102b that is relevant to the advertisement 103. For example, if during the video 102b a car is displayed, one or more interactive car advertisements (ideally the same type of car, but it could also be a competitor's car) may be timed to be displayed at or around the same time.

The customer 131 may interact, typically by clicking on the advertisement 103, with the advertisement 103, at any time while the advertisement 103 is being overlaid on the video 102. The video player 101, or other hardware or software on the customer client 130, may detect and receive the interaction of the customer 131 with the advertisement 103. (Step 202)

After the customer 131 has interacted with the advertisement 103, the customer's browser on the customer client 130 may be redirected to a webpage on the ecommerce server 110 so that one or more functions within the ecommerce functionality 111 may be performed. (Step 203)

A commercial transaction may be completed using the ecommerce functionality 111 operated on the ecommerce server 110. (Step 204) The ecommerce functionality may include, as a few non-limiting examples, selecting items for eventual purchase, collecting discount coupons or promotional codes, totaling the costs of the selected items (often including shipping costs and taxes), collecting payment and shipping information, storing purchase information, confirming and/or finalizing the purchase, receiving payment, and/or initiating procedures to perform the purchased services or for delivering the purchased items.

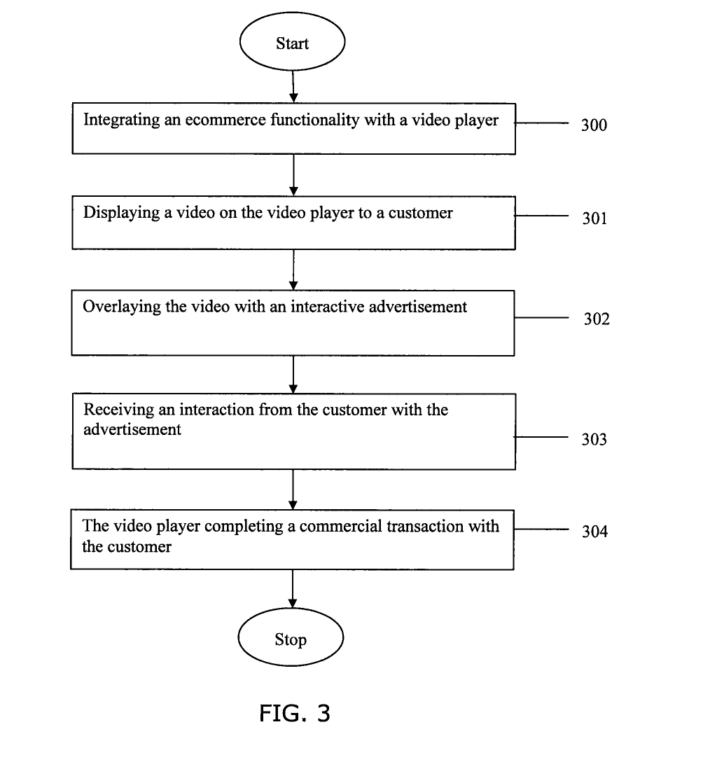

Another method for practicing the invention will now be described with reference to FIG. 3. In this embodiment, the ecommerce functionality 111 is integrated with the video player 101 and/or other hardware and/or software on the video server 100. (Step 300) The integration allows the video player 101 to call upon or utilize the ecommerce functionality 111 performed on the ecommerce server 110 during a commercial transaction, without having to redirect the customer's browser to the ecommerce server 110 running the ecommerce functionality 111.

As in the prior embodiment, a video 102b may be displayed to the customer 131 (Step 301) with an interactive advertisement 103 overlaid on the video 102b (Step 302). The customer 131 may interact, such as by clicking on the advertisement 103, with the advertisement 103. The interaction may be detected and received by the video player 101 and/or hardware and software operated on the customer client 130. (Step 303)

A commercial transaction may be conducted with the customer 130 using the video player 101 and without redirecting the customer 131 to a webpage on the ecommerce server 110. (Step 304) The video player 101 may communicate with the ecommerce functionality 111 run on the ecommerce server 110 using any known or later developed method to complete the transaction with the customer 131. In a preferred embodiment, the video player 101 on the customer client 130 may perform HTTP requests to the ecommerce server 110 and receive response messages to coordinate the commercial transaction with the ecommerce functionality 111 on the ecommerce server 110. The coordination may require the video player 101 to be integrated with the ecommerce functionality 111, whereby the video player 101 knows how to use the ecommerce functionality 111 running on the ecommerce server 110. In other, non-limiting examples, the video player 101 may use an API or remote function calls to coordinate the commercial transaction.

The data communicated between the video player 101/customer client 130 and the ecommerce functionality 111/ecommerce server 110 may relate to, as non-limiting examples, the availability of items, the selected items for eventual purchase, entered discount coupons or promotional codes, totals of the costs of the selected items (often including shipping costs and taxes), payment collection and shipping information, purchase information, confirmation and/or finalization of the purchase, payment receipt information, and/or initiating procedures to perform the purchased services or for delivering the purchased items. Not all of these forms of data must be used and additional data items may be used to complete the commercial transaction.

In another embodiment, an interactive advertisement may be transmitted to a customer client 130 by an advertisement server 100. The advertisement may be displayed on a webpage without being overlaid over a video 102b. (Step 401) In this embodiment, the advertisement itself may be integrated with an ecommerce functionality 111 of an ecommerce server 110 in a similar manner to that described above for the video player 101. (Step 400) Specifically, the interactive advertisement may be integrated with the ecommerce functionality 111 by overlaying additional HTML and/or scripts on top of the interactive advertisement that are run when the interactive advertisement is selected by a customer 131. (Step 402) The interactive advertisement and the ecommerce functionality 111 may be integrated such that they communicate and work together to complete a commercial transaction. (Step 403) In a preferred embodiment, the commercial transaction is completed without the customer 131 being referred, redirected, linked, and/or moved in any manner to another website. (Step 404) The communication between the interactive advertisement and the ecommerce functionality 111 is preferably bidirectional, in real time with the commercial transaction, and transparent to the customer 131. The communication may be by any known communication protocol or method now known or developed in the future.

Other embodiments and uses of the above inventions will be apparent to those having ordinary skill in the art upon consideration of the specification and practice of the invention disclosed herein. The specification and examples given should be considered exemplary only, and it is contemplated that the appended claims will cover any other such embodiments or modifications as fall within the true scope of the invention.

The Abstract accompanying this specification is provided to enable the United States Patent and Trademark Office and the public generally to determine quickly from a cursory inspection the nature and gist of the technical disclosure and in no way intended for defining, determining, or limiting the present invention or any of its embodiments.

1. A system, comprising:
a) a video server, comprising hardware, communicatively coupled to a computer network and configured to stream a video to a video player running on a customer client, wherein the video player is configured to:
i) receive and display the video;
ii) overlay an advertisement over the video, wherein the advertisement is configured to be interacted with by a customer using the customer client; and
iii) utilize an ecommerce functionality from an ecommerce server, comprising hardware, to complete a commercial transaction after the advertisement is interacted with by the customer, wherein the ecommerce server is a different server than the video server.

2. The system of claim 1, wherein the video player and the ecommerce functionality are not operated by the same entity.

3. The system of claim 1, wherein the video server and the ecommerce server are not owned by the same entity.

4. The system of claim 1, wherein the video player is configured to redirect the customer to a webpage, on the ecommerce server, that runs the ecommerce functionality.

5. The system of claim 1, wherein the ecommerce functionality is integrated with the video player.

6. The system of claim 1, further comprising:
b) a database storing a plurality of video locations and a plurality of advertisement locations.

7. A system, comprising:
a) an ecommerce server, comprising hardware, communicatively coupled to a computer network and running an ecommerce functionality, wherein:
i) the ecommerce functionality is configured to process a commercial transaction with a customer after the customer has interacted with an interactive advertisement displayed as an overlay on a video streamed from a video server, comprising hardware, and displayed on a video player, wherein the video player is run on a customer client, and
ii) the ecommerce server is a different server than the video server.

8. The system of claim 7, wherein the video player and the ecommerce functionality are not operated by the same entity.

9. The system of claim 7, wherein the video server and the ecommerce server are not owned by the same entity.

10. The system of claim 7, wherein the ecommerce functionality, running on the ecommerce server, is configured to receive the customer after the customer has been redirected, complete the commercial transaction with the customer, and redirect the customer back to a webpage on the video server.

11. The system of claim 7, wherein the ecommerce functionality, running on the ecommerce server, is configured to communicate with the video player during the commercial transaction with the customer and perform ecommerce functionality related to the commercial transaction with the customer, without the customer being redirected to a webpage on the ecommerce server.

12. The system of claim 7, further comprising:
b) a database storing a plurality of video locations and a plurality of advertisement locations.

13. A method, comprising the steps of:
a) integrating an interactive advertisement run on a customer client with an ecommerce functionality run on an ecommerce server, comprising hardware;
b) displaying the advertisement over a video on the customer client to a customer;
c) receiving an interaction from the customer with the advertisement; and
d) completing a commercial transaction with the customer using the integrated interactive advertisement and the ecommerce functionality.

14. The method of claim 13, wherein an advertisement server transmits the interactive advertisement to the customer client.

15. The method of claim 14, wherein the advertisement server and the ecommerce server are not owned by the same entity.

16. The method of claim 14, wherein the advertisement server and the ecommerce functionality are not operated by the same entity.

17. The method of claim 13, wherein the ecommerce functionality, running on the ecommerce server, is configured to communicate with the advertisement during the commercial transaction with the customer and perform ecommerce functionality related to the commercial transaction with the customer, without the customer being redirected to a webpage on the ecommerce server.

18. The method of claim 13, wherein the commercial transaction is completed without redirecting the customer to a webpage on the ecommerce server.

19. A method, comprising the steps of:
a) integrating an ecommerce functionality run on an ecommerce server, comprising hardware, with a video player run on a customer client;
b) displaying a video on the video player to a customer;
c) overlaying the video with an advertisement that may be interacted with by the customer;
d) receiving an interaction from the customer with the advertisement; and
e) completing a commercial transaction with the customer using the integrated ecommerce functionality.

20. The method of claim 19, wherein the video server and the ecommerce server are not owned by a same entity.

21. The method of claim 19, wherein the video player and the ecommerce functionality are not operated by a same entity.

22. The method of claim 19, wherein the advertisement is overlaid on the video at a particular cue point in the video.

23. The method of claim 19, further comprising the steps of:
f) calling a database to load a referral link associated with the video; and
g) displaying the referral link in the advertisement.

24. The method of claim 19, further comprising the steps of:
f) querying a database for advertisement information; and
g) building the advertisement from the advertisement information.

25. The method of claim 19, wherein the transaction is completed without redirecting the customer to a webpage on the ecommerce server.
